(19) United States
(12) Patent Application Publication
(10) Pub. No.: US 2010/0320885 A1
(43) Pub. Date: Dec. 23, 2010

(54) BATHROOM CABINET

(76) Inventor: Chin-Yung CHEN, Hua Tan Hsiang (TW)

Correspondence Address: HDLS Patent & Trademark Services, P.O. BOX 220746, CHANTILLY, VA, 20153-0746, US

(21) Appl. No.: 12/488,861

(22) Filed: Jun. 22, 2009

(51) Int. Cl. A47B 55/00; F16B 25/00; F16B 15/00

(52) U.S. Cl. 312/237; 411/378; 411/500

(57) ABSTRACT

The present invention discloses a bathroom cabinet including two first extruded strips and two second extruded strips enclosed to form a frame. The two first extruded strips and the second extruded strip include opposite slots for embedding a back panel, and through holes are disposed on both ends of the two first extruded strips, and corresponding rails are protruded from surfaces of the two second extruded strips for passing fasteners through the through holes of the two first extruded strips and locking the fasteners into the rails of the two second extruded strips respectively, such that the extruded strips can be adjusted to a required size according to a user's need, and the invention can enhance the structural strength of the bathroom cabinet.

### BACKGROUND OF THE INVENTION

(a) Field of the Invention

The present invention relates to a technical area of bathroom accessories, in particular to a do-it-yourself (DIY) bathroom cabinet having the features of a low cost, a convenient transportation and a good strength.

(b) Description of the Related Art

In general, bathroom cabinets are installed in bathrooms and provided for users to store necessary items such as washing and cosmetic products in the bathrooms. Most traditional bathroom cabinets are plastic frames manufactured by an injection molding process, not only occupying a large volume, but also incurring high costs for the injection mold, storage and transportation. Since the cabinets are plastic frames, the structural strength of the cabinets is weak. Furthermore, the size of the cabinets is fixed and cannot be adjusted according to a user's need, and thus causing issues in their applications; and users cannot assemble the cabinets by do-it-yourself (DIY), and thus constituting a limitation to a change of applications.

In addition to the aforementioned bathroom cabinet, there is another type of conventional bathroom cabinet made by welding stainless steel. Since stainless steel is heavy, and the overall welded cabinet comes with a fixed shape and a large size, and the size cannot be adjusted flexibly or the cabinets cannot be assembled by DIY, therefore it may be an issue for consumers to purchase the product.

### SUMMARY OF THE INVENTION

In view of the aforementioned shortcomings of the conventional bathroom cabinets, the inventor of the present invention provides a new design of a bathroom cabinet to overcome the issues of large volume, high cost, inflexible size adjustment and incapability of DIY of the conventional bathroom cabinets.

Therefore, it is a primary objective of the present invention to provide a bathroom cabinet capable of reducing storage and transportation volume, lowering costs, facilitating a size adjustment, providing a DIY assembly, and an enhanced structural strength.

To achieve the foregoing objective, the present invention provides a bathroom cabinet comprising: two first extruded strips, parallel to each other, and including at least one through hole disposed individually on both ends of the two first extruded strips, a slot concavely and individually disposed on a side opposite to the two first extruded strips, and at least one rail disposed at a position on a surface of the two first extruded strips corresponding to the through holes; two second extruded strips, parallel to each other, and installed between both ends of the two first extruded strips, and for enclosing the two first extruded strips and the two second extruded strips to form a frame, and including at least one second rail disposed at the two second extruded strips and corresponding to the through hole of the two first extruded strips, and a slot concavely and individually disposed at the two second extruded strips and corresponding to the slot of the two first extruded strips; a back panel, embedded into the slots of the two first extruded strips and the two second extruded strips; a plurality of fasteners, passing through the through holes of the first extruded strips, for fixing distal positions of the corresponding rails of the second extruded strips respectively.

### BRIEF DESCRIPTION OF THE DRAWINGS

FIG. 1 is a perspective view of a perspective view of a bathroom cabinet installed with a partition plate in accordance with the present invention;

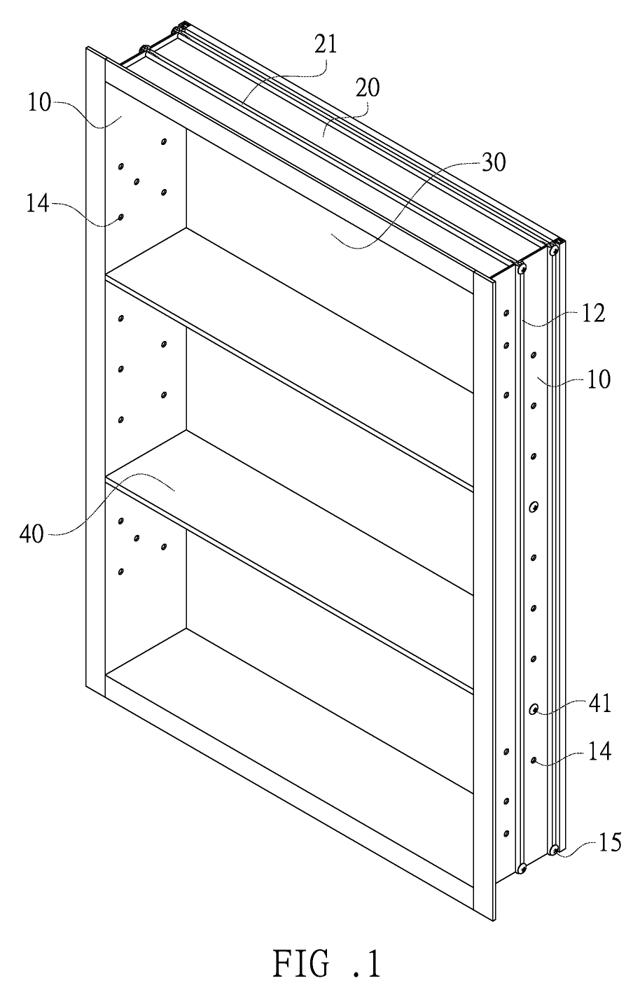

FIG. 2 is an exploded view of components of the present invention;

FIG. 3 is a partial enlarged view of FIG. 2;

FIG. 4 is a top view of the present invention; and

FIG. 5 is a perspective view of a bathroom cabinet installed with a mirror door in accordance with the present invention.

### DETAILED DESCRIPTION OF THE PREFERRED EMBODIMENTS

The present invention will now be described in more detail hereinafter with reference to the accompanying drawings that show various embodiments of the invention as follows.

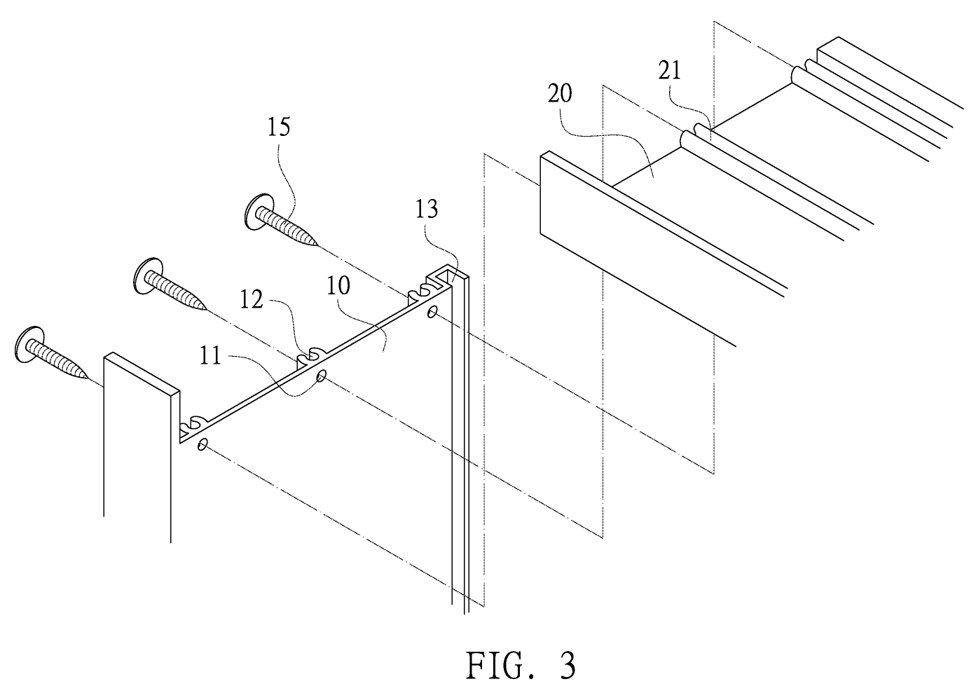

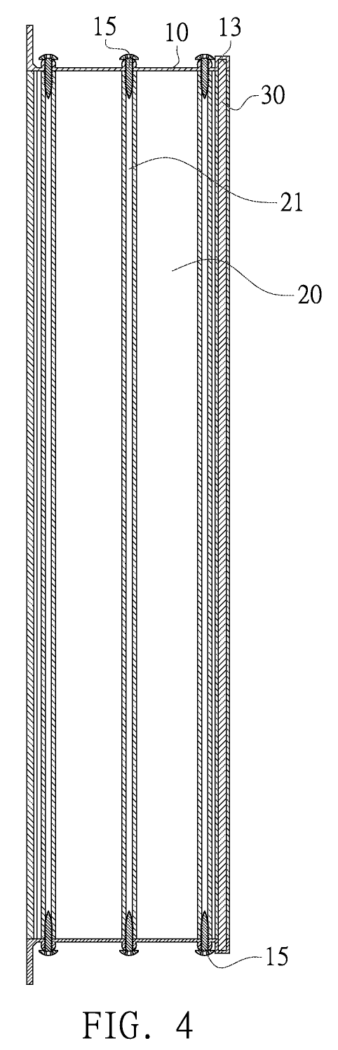

With reference to FIGS. 3 to 4 for a bathroom cabinet in accordance with the present invention, the bathroom cabinet comprises the following elements:

Two first extruded strips 10 parallel to each other are aluminum extruded and include at least one through hole 11 disposed individually at both ends of the two first extruded strips 10, and three through holes 11 are provided in this preferred embodiment as shown in the figures, and three first rails 12 are disposed on surfaces of the two first extruded strips 10 corresponding to the through holes 11 respectively, wherein the first rails 12 can be hollow, solid or two opposite crescent-shaped flanges as shown in the figures, and a slot 13 is disposed individually on a side and at opposite positions corresponding to the two first extruded strips 10 respectively, and a plurality of opposite positioning holes 14 are disposed between the two first extruded strips 10.

Two second extruded strip 20 parallel to each other are installed between the two first extruded strips 10, and the two first extruded strips 10 and the two second extruded strips 20 are enclosed to form a frame, and the two second extruded strips 20 include three second rails 21 disposed corresponding to the three first rails 12 of the two first extruded strips 10 respectively, and a slot 22 is disposed individually and concavely on the two second extruded strips 20 and corresponding to the slots 13 of the two first extruded strips 10 respectively.

A back panel 30 is embedded into the slots 13, 22 of the two first extruded strips 10 and the two second extruded strips.

A plurality of fasteners 15 are passed through the through holes 11 of the first extruded strips 10 and fixed to distal positions of the corresponding second rails 21 of the second extruded strips 20 respectively, wherein the fastener 15 can be a screw as shown in the figure for securing an end of the second rail 21, or the fastener can be a nail (not shown in the figure).

A plurality of partition shelves include a plurality of positioning elements 41 and at least one partition plate 40, and the positioning elements 41 are installed into the positioning holes 14 at same horizontal positions of the two first extruded strips 10 with at least one end protruded between the two first extruded strips 10 for holding the partition plate 40. With the aforementioned structure, a bathroom cabinet of the present invention is accomplished.

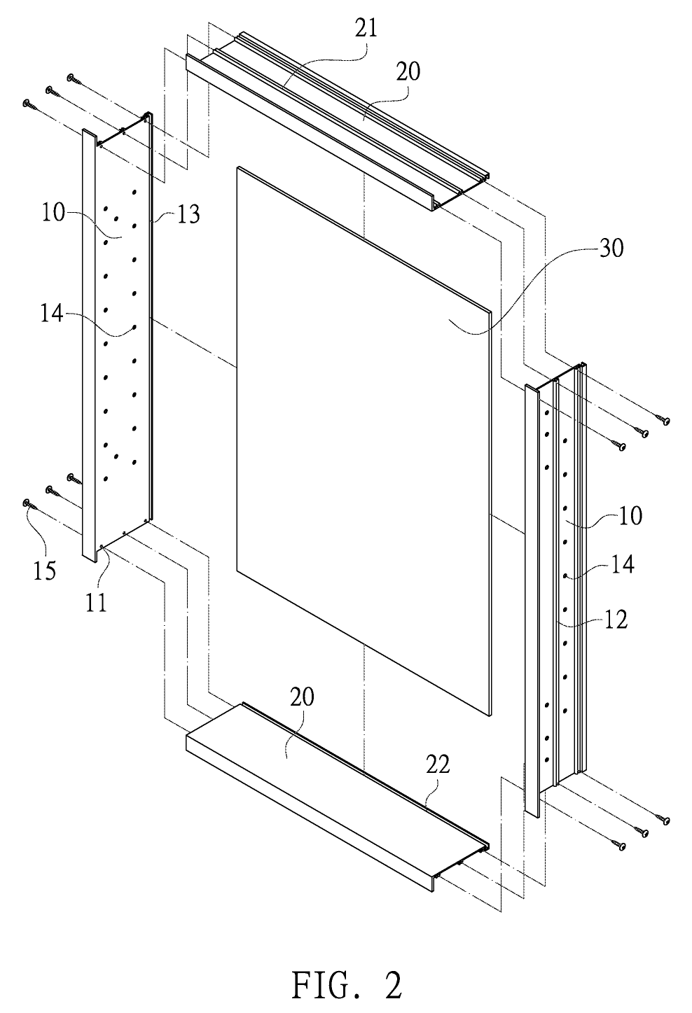

With reference to FIG. 2 for components of the present invention, the first extruded strip 10 and the second extruded strip 20 are manufactured by an extrusion concurrently to reduce the cost of the molds, and the size of the extruded strips 10, 20 can be adjusted according to a user's need to facilitate users to install and assemble the bathroom cabinet, and each extruded strip 10, 20 includes a plurality of rails 12, 21 to enhance the overall strength of the bathroom cabinet. Before assembling, the cabinet comes with a smaller volume to facilitate storage and transportation, so as to lower costs.

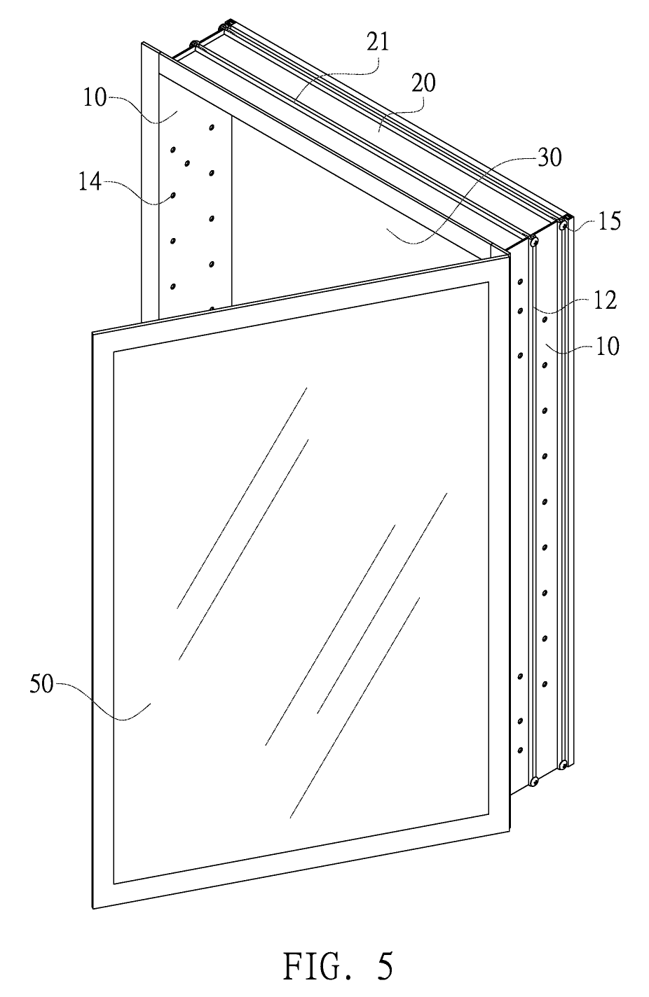

With reference to FIG. 5 for a bathroom cabinet of the present invention, the bathroom cabinet further includes a mirror door 50 pivotally coupled to one of the first extruded strips 30, such that a containing space is formed in the cabinet and provided for users to store things, so as to enhance the practical use of the cabinet.

In summation of the description, the present invention improves over the prior art and complies with the patent application requirements, and thus is filed for patent application. While the invention has been described by means of specific embodiments, numerous modifications and variations could be made thereto by those skilled in the art without departing from the scope and spirit of the invention set forth in the claims.

I claim:

1. A bathroom cabinet, comprising:
two first extruded strips, parallel to each other, and including at least one through hole disposed individually on both ends of the two first extruded strips, a slot concavely and individually disposed on a side opposite to the two first extruded strips, and at least one rail disposed at a position on a surface of the two first extruded strips corresponding to the through holes;
two second extruded strips, parallel to each other, and installed between both ends of the two first extruded strips, and for enclosing the two first extruded strips and the two second extruded strips to form a frame, and including at least one second rail disposed at the two second extruded strips and corresponding to the through hole of the two first extruded strips, and a slot concavely and individually disposed at the two second extruded strips and corresponding to the slot of the two first extruded strips;
a back panel, embedded into the slots of the two first extruded strips and the two second extruded strips; and
a plurality of fasteners, passing through the through holes of the first extruded strips, for fixing distal positions of the corresponding rails of the second extruded strips respectively.

2. The bathroom cabinet of claim 1, wherein the two first extruded strips and the second extruded strip are manufactured by an aluminum extrusion.

3. The bathroom cabinet of claim 1, wherein the through holes disposed on both sides of the two first extruded strips come with a quantity of three, and the rails of the second extruded also come with a quantity of three correspondingly.

4. The bathroom cabinet of claim 1, wherein the first rail and the second rail are hollow.

5. The bathroom cabinet of claim 1, wherein the first rail and the second rail are solid.

6. The bathroom cabinet of claim 1, wherein the first rail and the second rail are two opposite crescent-shaped flanges.

7. The bathroom cabinet of claim 1, further comprising a plurality of opposite positioning holes disposed between the two first extruded strips, a plurality of partition shelves, including a plurality of positioning elements and at least one partition plate, and the positioning elements being disposed in positioning holes at same horizontal positions of two first extruded strips respectively, and with at least one end protruded between the two first extruded strips for holding the partition plate.

8. The bathroom cabinet of claim 1, wherein the fastener is a screw.

9. The bathroom cabinet of claim 1, wherein the fastener is a nail.
